(19) United States
(12) Patent Application Publication
(10) Pub. No.: US 2008/0232026 A1
(43) Pub. Date: Sep. 25, 2008

(54) THIN FILM CAPACITOR AND METHODS OF MAKING SAME

(76) Inventor: Terence G. Ward, Redondo Beach, CA (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/688,279

(22) Filed: Mar. 20, 2007

(51) Int. Cl. H01G 4/06; B05D 5/12

(52) U.S. Cl. 361/311; 427/79

(57) ABSTRACT

A thin film capacitor and methods of making the capacitor are provided. The capacitor includes a first and a second conductive layer and a dielectric layer disposed therebetween. The dielectric layer includes a first polymer and a second polymer cross-linked to the first polymer. The capacitor may be made by forming a layer comprising a dielectric material including first and second polymers, each polymer capable of being cross-linked, and irradiating the layer to cross-link the first and second polymers and form the dielectric layer.

### TECHNICAL FIELD

The invention relates to thin film capacitors including dielectric materials capable of operation in high temperature environments and to methods of making such thin film capacitors.

### BACKGROUND OF THE INVENTION

Thin film capacitors generally include at least two electrodes separated by a dielectric layer. Each electrode is typically made of a conductive material, such as a metal. The dielectric layer is typically made of an insulating material chosen to achieve desired characteristics.

In automotive applications, the dielectric layer should have a high dielectric constant and relatively low dissipation values. For example, polypropylene is useful as a thin film capacitor insulating material and is relatively inexpensive to manufacture. Polyproplene also has additional properties that may be desirable as a dielectric layer, such as inherently low heat losses, dissipation factor (DF) values of between about 0.03% to about 0.1% when exposed to temperatures of about 25° C., and equivalent series resistance (ESR) values within a temperature range of between about −55° C. to about 105° C. Other suitable insulating materials include polyphenylenesulfide, polytetrafluoroethylene, polyimide and polyetheretherketone.

The aforementioned materials do not always provide the desired capacitance and dissipation values. For example, as the demand for more powerful, more compact engines increases, engine operating temperatures have also increased. Certain engines exhibit operating temperatures between about 140° C. to about 150° C. Materials such as polypropylene may not exhibit the desired properties when exposed to the increased operating temperatures. Although materials such as polyphenylenesulfide, polytetrafluoroethylene, polyimide and polyetheretherketone, may be used at higher operating temperatures, they are relatively expensive. Additionally, even if incorporated, these materials generally do not provide the same desired capacitance density as polypropylene.

Accordingly, it is desirable to provide a dielectric layer material that has a relatively high capacitance density when operating in temperatures ranging between about 140° C. and about 150° C. Additionally, it is desirable for the dielectric layer material to be inexpensive to manufacture. Furthermore, other desirable features and characteristics of the present invention will become apparent from the subsequent detailed description and the appended claims, taken in conjunction with the accompanying drawings and the foregoing technical field and background.

### SUMMARY OF THE INVENTION

A capacitor is provided that includes a first and a second conductive layer and a dielectric layer. The dielectric layer is disposed between the first and the second conductive layers and includes a first polymer and a second polymer cross-linked to the first polymer.

A method is provided for manufacturing a film capacitor having a dielectric layer. The method includes the step of forming a layer comprising a dielectric material including first and second polymers, each polymer capable of being cross-linked. The method also includes the step of irradiating the layer to cross-link the first and second polymers and form the dielectric layer.

### DESCRIPTION OF THE DRAWINGS

FIG. 1 is an isometric view of an exemplary capacitor;

FIG. 2 is a isometric view of the exemplary capacitor shown in FIG. 1 without an outer housing;

FIG. 3 is a isometric view of another exemplary capacitor;

FIG. 4 is a flow diagram of an exemplary method of forming a film that may be implemented in one of the capacitors shown in FIGS. 1-3;

FIG. 5 is a schematic representation of a conventional electron beam apparatus suitable for use in preparing a dielectric layer that may be implemented as part of the film shown in FIG. 4;

FIG. 6 is a cross section view of a winding configuration for a film-foil capacitor;

FIG. 7 is schematic representation of a winding configuration for a metallized film capacitor;

FIG. 8 is a cross section view of a winding configuration for a hybrid capacitor;

FIG. 9 is a cross section view of a winding configuration for a modified hybrid capacitor; and

FIG. 10 is a cross section view of a winding configuration for another modified hybrid capacitor.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

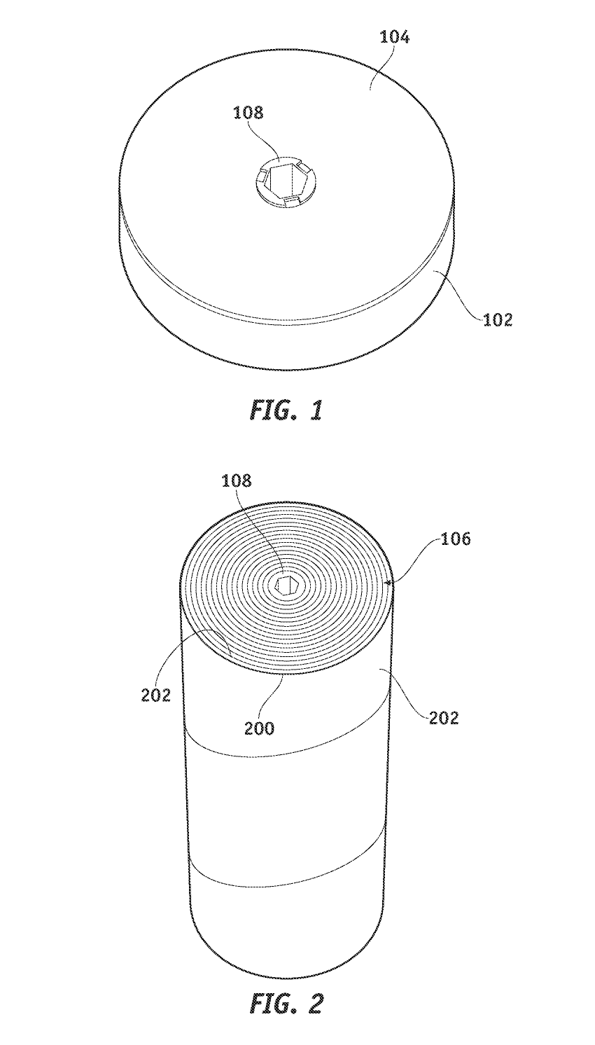

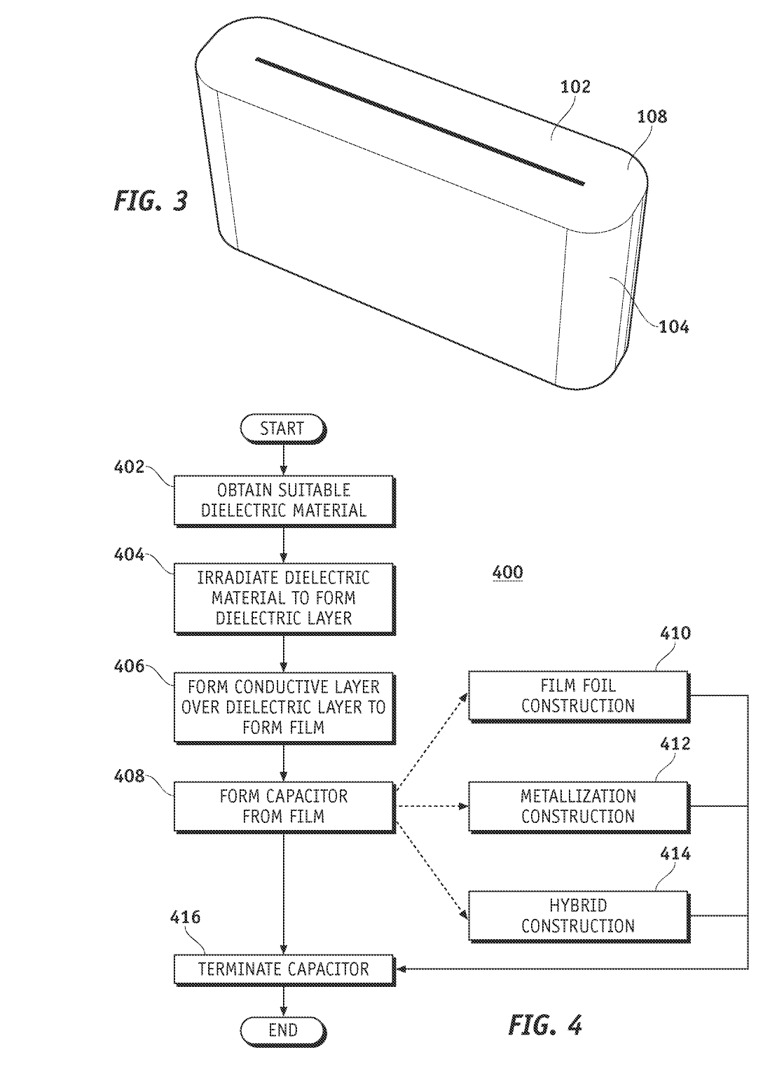

FIG. 1 is an isometric view of an exemplary capacitor 100. The capacitor 100 includes an outer insulating housing 102 and metal contacts 104 (only one of which is shown) on each end of the housing 102. Disposed within the housing 102 is a film 106 wound around a core 108, as shown in FIG. 2. The core may be cylindrical, rectangular, oblong (as shown in FIG. 3), or have any other conventional core shape. With continued reference to FIG. 2, the film 106 includes at least one dielectric layer 200 and at least one conductive layer 202. Because the film 106 is wound around the core 108, the dielectric layer 200 is consequently located between two conductive layers 202.

The dielectric layer 200 is formed such that it has a high capacitance density, relatively low dissipation values, and is substantially resistant to heat shrinkage and creep when exposed to temperatures in the range of between about 140° C. and about 160° C. To obtain these desirable properties, the dielectric layer 200 includes a first polymer that is cross-linked to at least a second polymer. Polymers suitable for cross-linking and inclusion in the dielectric layer 200, include, but are not limited to homopolymers and copolymers of polyesters and polyolefins. Examples of suitable polyesters include, but are not limited to polyethyleneterephthalate, polyphenyleneterephthalate, and polyethylenenaphthalate. Examples of suitable polyolefins include, but are not limited to, low polymerization grade polyethylene (“LPPE”), linear low density polyethylene (“LLDPE”), high density polyethylene (“HDPE”), ultra-high molecular weight polyethylene (“UHMWPE”), homopolymers and copolymers of polypropylene; homopolymers and copolymers of polyvinylidene fluoride; polychlorotrifluoroethylene, and polytetrafluoroethylene.

In embodiments in which propylene copolymers are included, the propylene copolymer may include between about 80 and about 97 mole percent propylene and between about 3 and about 20 mole percent of at least one other olefin, other than propylene, having between 2 to 8 carbon atoms. In these embodiments, the polypropylene copolymer employed may be one that has a melting point of between about 90° C. and about 140° C. Specific examples of suitable propylene copolymers, include, but are not limited to propylene/ethylene copolymers, propylene/butene copolymers, propylene/ethylene/butene terpolymers, and copolymers of propylene and multifunctional monomers. The monomers can be random in configuration or in blocks to form a block of copolymer.

In one exemplary embodiment, in addition to the cross-linked polymers, the dielectric layer 200 includes other constituents that enhance certain desired characteristics of the layer 200. For example, the dielectric layer 200 may also include multifunctional monomers such as triallylisocyanurate or trimethyrolpropanetrimethacrylate in an amount of between about 3 to about 20 mole percent. Addition of these monomers may control or lower the crystallinity of the dielectric layer 200, which can help in irradiating the polymer.

The dielectric layer 200 may have a thickness of between about 0.01 microns and about 125 microns, depending on the intended use. Common thicknesses for dielectric layers fall within the range of about 0.2 microns to about 30 microns, and in some cases, within the range of about 2.5 microns to about 20 microns. For example, in A/C and D/C capacitors, the dielectric layer 200 may have a thickness that ranges from between about 3 microns to about 10 microns. For electric power capacitors, the dielectric layer 200 can have a thickness of about 15 microns to about 25 microns. In other embodiments, a thin dielectric layer 200, e.g. 0.1-3 microns, is formed in order to increase the capacitance of the film 106. In such case, the dielectric layer 200 is also formed pinhole-free.

The conductive layer 202 is formed over the dielectric layer 200, and the two layers may or may not be in direct contact with each other. For example, in one embodiment, the conductive layer 202 may be deposited on the dielectric layer 200. Alternatively, the conductive layer 202 may be spaced apart from the dielectric layer 200. Any one of numerous conventional conducting materials may be employed. Suitable conducting materials include, but are not limited to, aluminum, iron, tin, zinc, palladium, gold, copper, silver, nickel or an alloy or any combination thereof.

FIG. 4 is a flow diagram of an exemplary method 400 for forming the film 106. First, a suitable dielectric material is obtained, step 402. The dielectric material may be an uncross-linked variant of any one of the suitable dielectric layer 200 polymers discussed above. Next, the dielectric material is irradiated to form the dielectric layer 200, step 404. Irradiation causes cross-linking of at least a portion of the molecules that make up the dielectric material. The dielectric material may be irradiated so that it is partially cross-linked. In some embodiments, the dielectric material may include cross-linked polymers in predetermined regions.

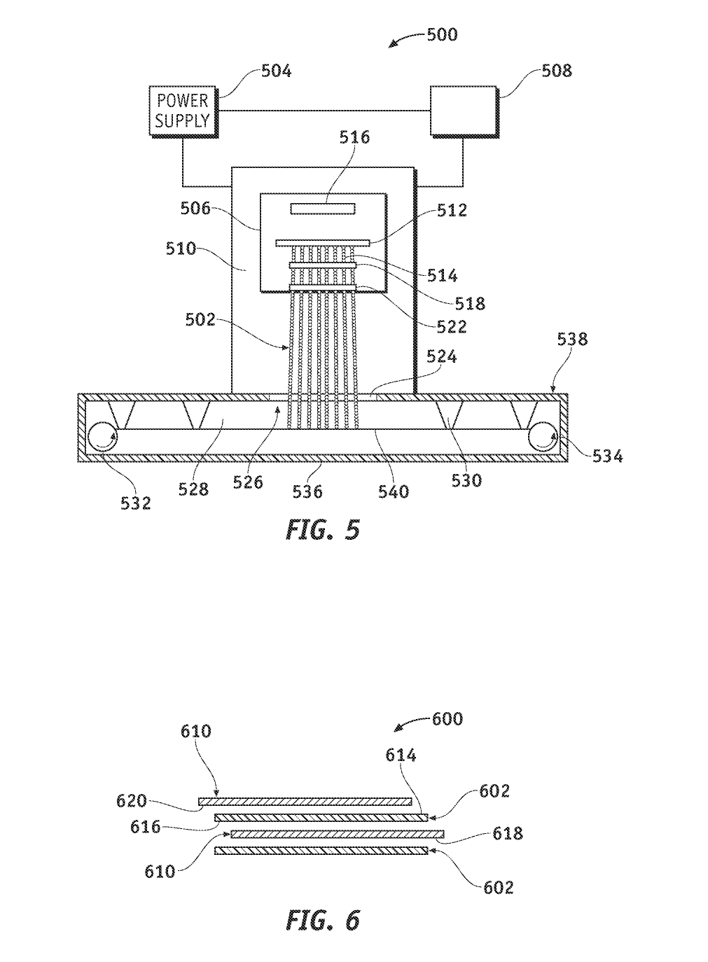

Irradiation may be performed using known techniques. In one example, irradiation is performed by electron beam processing utilizing a conventional electron beam generator, such as model CB-175 available from Energy Sciences Inc. of Wilmington, Mass., coupled with an appropriate material handling apparatus. FIG. 5 depicts a conventional electron beam apparatus 500 which can be used to irradiate dielectric material 540. The electron beam apparatus 500 produces an electron beam 502 (e-beam) that is guided through an electron gun assembly 506 toward the dielectric material 540. In this regard, when a suitable voltage magnitude from a high voltage power supply 504 is applied to a tungsten wire filament 512, electrons 514 are produced that form the e-beam 502. The e-beam 502 is directed through the electron gun assembly 506 by a repeller plate 516 and an extractor grid 518. The repeller plate 516 is maintained at a negative charge potential to repel and accelerate the electrons 514 toward the extractor grid 518. A computer 508, in operable communication with the power supply 504, controls the magnitude of the e-beam 502.

The e-beam 502 is then guided toward a terminal grid 522 and exits the gun assembly 506 through a window 524 into a gap 526. The gap 526 size can vary between about 2 mm and about 100 mm among conventional electron beam generators, depending on the voltage used and the material being irradiated. The gap 526 contains an atmosphere 528, which is typically nitrogen, that is fed through nozzles 530. After passing through the atmosphere 528, the electrons 514 travel into the dielectric material 540, which is positioned proximate the window 524. The dielectric material 540 is transported across the window 524 via two rollers 532, 534. A support substrate (not shown) may optionally hold the dielectric material 540. A beam collector 536 within a chamber 538 collects any residual electrons 514. The rotational speed of the rollers 532, 534 is such that the dielectric material 540 moves across the window 524 at a rate appropriate for receiving an irradiation dose suitable for forming a pinhole-free cross-linked polymeric dielectric film. It should be understood that the configuration of the electron beam apparatus and method for preparing the dielectric layer 200 can vary widely. For example, two electron beams can be used to irradiate the film sequentially or the film may be passed under the same e-beam 502 twice, either to expose the same surface of the film twice or to expose each surface once. In other embodiments, multiple passes (e.g. more than two) may be used.

To determine the irradiation dose that is suitable for forming a desired degree of cross-linking in the dielectric layer 200, a predetermined depth/dose profile may be used. The depth/dose profile may be obtained by exposing the material to multiple of beams each having different voltages and by measuring physical properties of the material, such as temperature resistance at each dose. The depth/dose profile may include measurements collected when the dielectric material is exposed to the e-beam 502 at various rates of speed at which the dielectric material travels across the window 524, when subjected to different voltages, and when the e-beam 502 penetrates the material at different depths. The profile can also be used to compare the actual dose provided to the dielectric material with an indicated instrument current and to calibrate the apparatus 500.

In any case, the total irradiation dose employed will depend on the particular dielectric material selected and the degree of cross-linking desired. In irradiating the dielectric material, a suitable dose of electrons is provided to and through the material such that it is adequately modified through cross-linking to provide a desired increase in use temperature. Typically, however, the dose should not degrade the desired properties of the polymer. For example, low-density polyethylene (LDPE) frequently experiences a significant level of cross-linking at 240 kiloGrays or so, whereas other polypropylene copolymers may be subjected to over 400 kiloGrays to achieve suitable cross-linking under certain conditions.

After the dielectric layer 200 is formed, one or more of the conductive layers 202 are formed over the dielectric layer 200, step 406. The conductive layers 202 may be formed on or over any suitable portion of the dielectric layer to provide electrodes. For example, the conductive layers 202 may be positioned on either side of the dielectric layer 200. The conductive layer 202 can be formed by any one of numerous conventional metal deposition methods, such as, by, for example, vacuum deposition, metallization, sputtering, or ion implantation. In embodiments in which the conductive layer 202 is deposited directly onto the dielectric layer 200, the conductive layer 202 may be subjected to a corona discharge in air, nitrogen or CO₂ which thereby improves adhesion to the dielectric layer 200 material. The conductive layer 202 typically ranges from about 0.03 microns to about 0.3 microns in thickness and can include aluminum.

In some embodiments, the dielectric layer 200 may be incorporated into the capacitor 100, step 408. The capacitor 100 may be film-foil constructed (step 410), metallized (step 412), or may have a hybrid construction (step 414). One exemplary film-foil constructed capacitor 600 is shown in FIG. 6 (step 410). In this embodiment, the conductive layers 610 are metal foils that are disposed over the dielectric layers 602 and that extend out to opposite sides of the capacitor 600. Additionally, the conductive layers 610 are offset on each side of dielectric layers 602 to create end margins 614, 616 and foil extensions 618, 620. The margins 614, 616 may be bonded to the foil extensions 618, 620. Alternatively, especially with aluminum foil and high current power electronic applications, the foils 610 may be sprayed with a metal end spray to connect all the exposed foil end margins 614, 616 and foil extensions 618, 620 with each other. This configuration assists in keeping the capacitor 600 cool under high current applications.

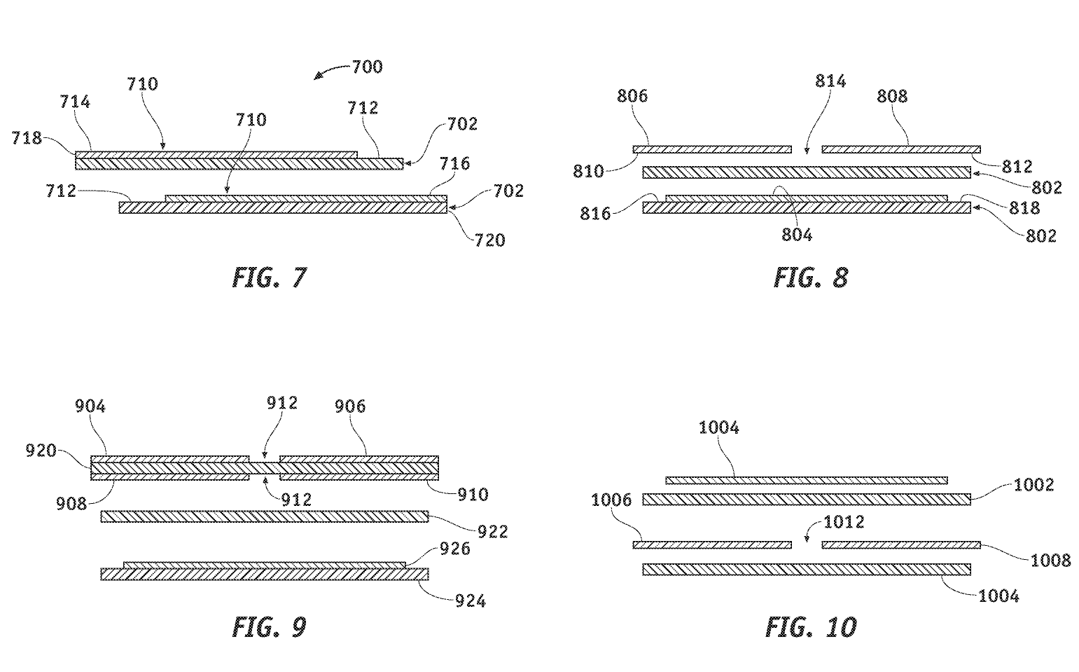

In a metallized winding construction, step 412, as shown in FIG. 7, the conductive layer 710 is deposited directly onto the surface of the dielectric layer 702. The conductive layer 710 is typically a few hundred Angstroms in thickness, and may be made of aluminum, zinc, or a combination thereof. The conductive layer 710 is disposed such that it forms margins 712 and offsets 714, 716 on the dielectric layer 702. A metal end spray is applied to each end 718, 720 and on at least a portion of the conductive layer 710 extending from each of the end 718, 720 to thereby connect all the conductive layers 710 together. In this embodiment, because the conductive layer 710 is relatively thin, very little air is entrapped inside the capacitor 700. As a result, an AC corona inception voltage is provided that is higher than that of the film-foil capacitor 600 (shown in FIG. 6). Additionally, should the capacitor 700 operate at AC voltages above corona inception, the likelihood of failure from a shorted condition is greatly reduced compared to the film-foil capacitor 600.

A hybrid construction offers the advantage of both the film-foil and metallized constructions. It utilizes foil connections for end terminations that provide high current carrying capability and a metallized interconnection layer that provides improved reliability because of the self-healing phenomenon. FIG. 8 illustrates one exemplary hybrid capacitor 800 (step 414). The capacitor 800 includes a conductive layer 804 and two metal foils 806, 808 that form two capacitors in series within a single winding. The conductive layer 804 is disposed on the dielectric layer 802 to link the two capacitors together. Each of the metal foils 806, 808 provides a separate capacitor with the dielectric layer 802. The metal foils 806, 808 are positioned to provide foil extensions 810, 812 and a center margin 814. The conductive layer 804 is positioned on the dielectric layer 802 to provide end margins 816, 818. This offers the advantage of using thinner dielectrics since each capacitor equally shares the voltage.

In another exemplary embodiment of a hybrid capacitor 900 (step 414), as shown in FIG. 9, three dielectric layers 920, 922, 924 are included. A top dielectric layer 920 includes conductive layers 904, 906 on one side and conductive layers 908, 910 on the opposite side so as to provide center margins 912 on each side. A middle dielectric layer 922 separates the top dielectric layer 920 from a bottom dielectric layer 924 having a conductive layer 926 formed thereon. The hybrid capacitor 900 is robust and able to handle higher currents, provides lower ESR and DF values, and improves the heat transfer capability of the winding. Should higher AC voltage ratings become necessary, capacitor sections can be added with adjustments in size, capacitance values and dielectric thickness.

Under severe high current or voltage conditions, the metallized interconnection (e.g. layers 802, 804) of the hybrid configuration of FIG. 8 may be replaced with a foil, creating a film-foil two-section capacitor. FIG. 10 illustrates this construction (step 414). In this embodiment, two dielectric layers 1002, 1004 are shown and neither are metallized. Instead, one metal foil 1004 is placed over the top dielectric layer 1002 and two additional metal foils 1006, 1008 are disposed between the two dielectric layer 1002, 1004. The two additional metal foils 1006, 1008 are disposed on substantially the same plane and are spaced apart from each other to provide a center margin 1012 therebetween.

The capacitors described above can be terminated by conventional methods, step 416, using convention components such as a single solid wire, multiple-solid wire leads, ribbon or tab leads, bolt down lug or ribbon terminals or braid leads. In other embodiments, the capacitors may be annealed to exclude air by fusing plastic layers together, or may be impregnated with one or more of vegetable oils, mineral oils, or waxes, and to hermetically seal the capacitor.

The size and configuration of the capacitor can vary widely and can have a capacitance within the range of 0.001 μF to 5000 μF. The capacitors may be used in a wide range of applications, from small electronic components in portable devices (chip capacitors) to large scale industrial equipment (power capacitors) such as that used in high-voltage power delivery and drive motor controls for trains and hybrid automobiles (100 to 1000+ volts).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A thin film capacitor comprising:
a first and a second conductive layer; and
a dielectric layer disposed between the first and the second conductive layers, the dielectric layer comprising a first polymer and a second polymer cross-linked to the first polymer.

2. The capacitor of claim 1, wherein the cross-linked first and second polymers comprises a constituent selected from the group consisting of homopolymers of polyolefins, copolymers of polyolefins, homopolymers of polyesters, and copolymers of polyesters.

3. The capacitor of claim 1, wherein the dielectric layer is substantially resistant to heat shrinkage and creep when exposed to temperatures in the range of between about 140° C. and about 160° C.

4. The capacitor of claim 1, wherein at least a portion of the dielectric layer has a thickness in the range of between about 0.01 micron to about 125 microns.

5. The capacitor of claim 1, wherein the capacitor has a capacitance within the range of between about 0.001 μF to about 5000 μF.

6. The capacitor of claim 1, wherein the dielectric layer has a surface and the conductive layer is disposed on the dielectric layer surface to form at least one electrode of the capacitor.

7. The capacitor of claim 1, wherein at least one of the first and the second conductive layers comprises a metal selected from the group consisting of aluminum, zinc, copper, and manganese.

8. The capacitor of claim 1, wherein at least one of the first and second conductive layers is a metal foil.

9. The capacitor of claim 8, wherein another metal foil is disposed in a substantially similar plane as the other metal foil and is spaced apart from the other metal foil to form a center margin therebetween.

10. The capacitor of claim 1, wherein both of the first and second conductive layers are metal foils.

11. A method for manufacturing a thin film capacitor having a dielectric layer, the method comprising the steps of
forming a layer comprising a dielectric material including first and second polymers, each polymer capable of being cross-linked; and
irradiating the layer to cross-link the first and second polymers and form the dielectric layer.

12. The method of claim 11, further comprising the step of forming a conductive layer over the dielectric layer.

13. The method of claim 12, wherein the step of forming the conductive layer comprises depositing conductive material onto the dielectric layer.

14. The method of claim 11, further comprising the steps of forming a second conductive layer and placing the dielectric layer between the first and second conductive layers.

15. The method of claim 11, wherein the step of irradiating comprises generating an electron beam and directing the beam at the layer.

16. The method of claim 11, wherein the step of forming comprises forming a layer from a material comprising a constituent selected from the group consisting homopolymers of polyolefins, copolymers of polyolefins, homopolymers of polyesters, and copolymers of polyesters.

17. A method for manufacturing a thin film capacitor having a dielectric layer and a conductive layer, the method comprising the steps of forming a layer comprising a dielectric material including a first and a second polymer, each polymer capable of being cross-linked;
generating an electron beam and directing the beam at the layer to cross-link the cross-linkable polymers and form the dielectric layer; and
depositing a conductive material over the dielectric layer.

18. The method of claim 17, wherein the step of forming the conductive layer comprises depositing conductive material onto the dielectric layer.

19. The method of claim 17, wherein the film capacitor includes a second conductive layer and the method further comprises placing the dielectric layer between the first and second conductive layers.

20. The method of claim 17, wherein the step of forming comprises forming a layer from a material comprising a constituent selected from the group consisting of homopolymers of polyolefins, copolymers of polyolefins, homopolymers of polyesters, and copolymers of polyesters.
